(19) United States
(12) Patent Application Publication
(10) Pub. No.: US 2007/0013197 A1
(43) Pub. Date: Jan. 18, 2007

(54) Pyrotechnic actuator

(75) Inventors: Rolf Bender, Siegen (DE); Wolfgang Hamm, Mauden (DE); Markus Ermert, Burbach (DE); Michael Stockschlager, Herdorf (DE); Axel Muller, Siegen (DE)

Correspondence Address: THE FIRM OF KARL F ROSS, 5676 RIVERDALE AVENUE, PO BOX 900, RIVERDALE (BRONX), NY, 10471-0900, US

(73) Assignee: THOMAS MAGNETE GmbH

(21) Appl. No.: 11/487,136

(22) Filed: Jul. 14, 2006

(30) Foreign Application Priority Data
Jul. 15, 2005 (EP) 05015381.6

(51) Int. Cl. F01B 29/00; E05C 3/06

(52) U.S. Cl. 292/201; 60/512

(57) ABSTRACT

A part normally retained in a predetermined position is operated by a pyrotechnic actuator having a housing formed unitarily with a pivot, formed unitarily with mounts for securing the housing to a motor vehicle, and forming a chamber extending along an axis. A latch element is mounted on the pivot and movable thereon between a holding position retaining the part in the predetermined position and a releasing position allowing the part to move out of the predetermined position. A piston having a stem engageable with the latch element is movable axially in the chamber between an inner position with the latch element in the holding position and an outer position with the latch element in the releasing position. A pyrotechnic charge in the chamber is detonatable to shift the piston into the outer position and thereby shift the latch element into the releasing position.

### FIELD OF THE INVENTION

The present invention relates to a pyrotechnic actuator. More particularly this invention concerns such an actuator normally used in a motor vehicle to release a latched element in the event of a collision.

### BACKGROUND OF THE INVENTION

A pyrotechnic actuator system with a housing having a chamber in which a piston is movable between an inner rest position and an outer an end position by a quantity of gas released by the ignition of an ignition element or pyrotechnic charge provided in the chamber. A rod of the piston triggers an action when moving into the end position, typically by acting on a latch element to unlock it. This latch element is normally in a holding position retaining a functional part but can move into a releasing position letting this element or part. Such a pyrotechnic actuator is described in U.S. Pat. No. 6,851,372.

A pyrotechnic actuator of this type serves for quickly releasing functional parts, such as for example airbags, belt tighteners, roll bars, covers or other elements that are normally locked and have to be released by force, for example in case of an accident.

As far as actuation means that are pyrotechnically actuated are concerned, a preloaded actuation system is provided by means of which a functional part of the motor vehicle or the like is kept in a locked position. The corresponding latch element can be pyrotechnically moved so that the functional part is released from the rest position into the end position by the action of a force, preferably by the action of a spring. Such actuator systems are composed of several components. Amongst others, there have to be necessarily provided: a mount for the functional part, for example a latch, a pivot fastening for fastening the pivot to the car body or parts of the frame, fastening and securing elements, flange elements for fastening the actuator to corresponding fixedly provided components, a spring, the actuator itself as well as fastening means for the actuator. The mount, for example, receives the actuator and therefore determines its size. As a result, a comparatively large installation space is required. The production of the single parts as well as their installation is comparatively cost intensive, such that such systems in total are comparatively expensive. Furthermore, in such known systems with pyrotechnic actuators the energy released cannot be exactly dosed. Hence, surplus energy can lead to undesired effects, such as deformations of downstream components. Furthermore, large efforts as far as time and safety are required and necessary for installation of the components required for the ignition of the actuator in order to avoid self-ignition. In this regard, special measures have to be taken on the production site in order to guarantee safety.

### OBJECTS OF THE INVENTION

It is therefore an object of the present invention to provide an improved pyrotechnic actuator.

Another object is the provision of such an improved pyrotechnic actuator that overcomes the above-given disadvantages, in particular that can be produced and installed at low cost, that requires only a small installation space, and that is extremely functional.

### SUMMARY OF THE INVENTION

Thus according to the invention a part normally retained in a predetermined position is operated by a pyrotechnic actuator having according to the invention a housing formed unitarily with a pivot, formed unitarily with mounts for securing the housing to a motor vehicle, and forming a chamber extending along an axis. A latch element is mounted on the pivot and movable thereon between a holding position retaining the part in the predetermined position and a releasing position allowing the part to move out of the predetermined position. A piston having a stem engageable with the latch element is movable axially in the chamber between an inner position with the latch element in the holding position and an outer position with the latch element in the releasing position. A pyrotechnic charge in the chamber is detonatable to shift the piston into the outer position and thereby shift the latch element into the releasing position.

According to this embodiment, a compact configuration is achieved by integrating all necessary components in or respectively on a housing. The housing can be designed as one piece or in several parts.

Not only the actuator, the pyrotechnic charge and essential components of the actuator system are integrated in the housing, but also the components by means of which the system can be fastened to parts of a motor vehicle are provided in or respectively on the housing as integral components. The housing contains the component for the activation, which means the piston and its element-engaging stem, as well as the latch element that has to be supported and positioned in at least one pivot of the housing.

Since all essential components of the system for quick actuation are components of the housing, all components can be made by the producer of this system unit, so that the user, that is the motor-vehicle manufacturer, only has to mount the particular system to the corresponding components of the car body or the like. The work during final installation is reduced and defects due to faulty installation can be largely excluded.

The housing basically can consist of any material, as long as aspects concerning safety are considered. In particular, this housing has to be fireproof and sufficiently stable. Usually such housing can consist of metal, for example of a die-cast part. It is, however, equally possible to use other robust materials for the housing.

In a preferred embodiment of the invention, the latch element consists of a locking pawl, the support of which is a pivot pin integrally connected to the housing or a similar support means that is penetrated by the pivot pin.

The provision of a pawl as latch element is generally known, but one specific feature consists in the fact that the pivot for the latch element, for example a pivot pin or a different pivot means is an integral component of the housing. Thus, the right dimensions and orientation are already guaranteed during production of the housing, such that no faults resulting from final installation can emerge. Additionally, effort necessary for installation and as well for production is reduced.

Furthermore, it is preferably provided that the latch element, particularly the pawl is kept in a rest position by a biasing means.

It is additionally provided that the latch element, particularly the pawl, is held in a rest position by a mechanical spring and can be moved against the action of the spring into the initiating position by means of the piston rod.

Furthermore, it may be provided in a generally known manner that the biasing means or the spring is installed on the support point where it is, on the one hand, propped against the housing and on the other hand against the latch pawl or the like. This biasing means can be a hairpin spring, a torsion spring or a spring washer.

It is known to provide a damping element, for example in form of an O-shaped ring is provided, such that, when the pyrotechnic actuator is activated, the piston is moved together with the piston rod and the O-shaped ring is squashed between the piston and the wall penetrated by the piston rod, in order to seal and also in order to damp the movement thus protecting the housing material and reducing noise.

Based on this state of the art, it is the special object of the invention to provide simple means, with the help of which the energy released by a pyrotechnic actuator can be partially dissipated such that undesired effects, such as deformations of downstream components, can be avoided.

For this purpose, the invention proposes that the damping means be composed of parts of the housing that are provided close to or at the perforated housing floor, that can be penetrated by the piston rod, wherein the damping means is formed by ribs formed on the housing floor or the housing wall, and/or bars formed on the housing floor projecting in the direction of the piston or a sleeve and/or a conical tapering of the chamber of the housing close to the housing floor.

To this end, ribs formed on the housing and the wall of the housing may be provided that engage the piston in case of ignition, whereupon these ribs are deformed plastically so that they transform extra energy into deformation action.

Alternatively or additionally, sleeve-like projections or bars can be provided in place of or in addition to the ribs that are hit by the piston in the ignited state and deformed by the force of the piston, particularly plastically deformed Finally, a conical tapering of the chamber may be alternatively or additionally provided so that the piston in the ignited state reaches the area of the conical tapering and is used there for plastic deformation of material, which leads to a loss of energy.

Alternatively or additionally it may also be provided that the damping means be formed by an insert, particularly a ring-shaped insert, made of metal and/or plastic, provided between the perforated housing floor and the piston that can be preferably plastically deformed by the ignited piston.

This eliminate the need for an improved solution of the further problem of the state of the art relating to the fact that large efforts regarding time and safety are necessary for the installation of the components required for the ignition of the actuator.

For this purpose, the invention as autonomous inventive element proposes a solution whereby the pyrotechnic charge together with the shorting bar and the retainer are imbedded in a formed element, in particularly a formed sleeve and positioned such that it is stable and cannot be deformed, characterized in that the formed element or the formed sleeve are inserted in a corresponding recess in the housing and the front side of the formed element or of the formed sleeve facing the piston serves as axial buffer for the piston.

This way the pyrotechnic charge together with the shorting bar and the retainer can be embedded in a corresponding formed element or formed sleeve by the producer, so that all components in this sleeve or in this formed element are positioned such that they are stable and cannot be deformed. The manufacturer of the system for quick actuation can then insert the prefabricated element in the housing and fix it thereto in a simple way. No special safety regulations have to be considered during this procedure, so that at the production site of the manufacturer of the system for quick actuation corresponding safety measures as well as installation-related measures are dispensable.

In this connection, it is particularly provided that the housing has a cylindrical chamber that is open axially to one side, into which the formed element or formed sleeve is fittingly inserted and that is coaxially adjoined by the cylindrical chamber, receiving the piston with the piston rod.

Such an embodiment allows the housing to be for example designed in one piece and permits that the chamber as well as the chamber are for example produced in a casting mold by die casting, wherein only the perforation of the floor wall of the char has to be carried out later, so that the piston rod can reach through this perforation. This solution is advantageous even if housing is designed in more pieces.

Furthermore, it is preferably provided that the pyrotechnic charge projects over the formed element or the formed sleeve and engages in the corresponding tapered chamber opposite of the chamber.

Therein, it can be preferably provided that the pyrotechnic charge has a sealing ring at its end projecting over the chamber that sealingly abuts the inner shell of the chamber or the chamber.

In order to make sure that the piston together with the piston rod cannot move in the rest position, which might result in rattling noises, the pyrotechnic charge at its end facing the piston is disposed with one or several distance elements abutting the piston in its inner rest position.

It may be provided in a manner generally known that the housing consists of several, preferably two longitudinally separated part that are held together by fastening means in the standard installation position. The parts of the housing may for example be connected by joining, screwing, clipping or calking. In one preferred embodiment, a spring clamp is provided as fastening means encompassing the outer shell of the basically cylindrical housing. In a particularly preferred embodiment the fastening means is a spring-elastic conical clamping sleeve that is slid on under preload onto the two-part housing and that surrounds the outer shell of the basically cylindrical housing.

Both solutions described have the advantage that the housing does not have to be fabricated with extreme precision, since production tolerances can be compensated for by the elastic fastening means, for example due to the spring clamp or the spring-elastic conical clamping sleeve, so that despite any existing production tolerance variations a stable fastening of the parts to each other is guaranteed. If a conical clamping sleeve is used, this sleeve may be axially slid on the corresponding part of the housing, the clamping sleeve being elastically stretched and preloaded in the final state when slid on the housing.

In a further preferred embodiment the latch element, particularly the pawl is pivotally mounted between two pivot eyes of the housing around a pivot pin engaging in the pivot eyes. The pivot eyes being in areas, along which parts of the latch element or the pawl move when shifted from the retaining position in the releasing position. The latch element dispose of projections forming a clamping zone or material accumulations narrowing the gap for engaging between the pivot eyes so that the movement of the latch element is slowed down.

It is preferably provided that the projections or material accumulations can be plastically deformed by the action of the latch element.

In this embodiment, the pawl or the like cannot spring back from the releasing position when the actuator is activated and thus possibly disturb the unlocking procedure. Instead, the latch element, particularly the pawl is retained between the pivot eyes. The plastic deformation of the projection or material accumulations occurs due to movement of the latch.

The embodiment according to the invention has significant advantages compared to the state of the art. The latch element in particular is generally very compact, so that only a small installation space is required. The latch element, particularly the latch system together with the spring element is fixedly connected to the housing of the actuator. The limit stop of the piston carrying the ignition rod is damped. Consequently, deformations of downstream components can be constructively avoided. All in all, the actuator system can be cost-effectively manufactured and allows a low-cost, preferably automatic, installation. The ignition unit that combines all functional parts in one component, simplifies the installation and improves the safety of the process.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one FIG. but identical to those of another refer to structure that is functionally if not structurally identical. In the accompanying drawing:

FIG. 1 is a side view partly in section;

FIG. 2 is a large-scale view of a detail of FIG. 1 in side view;

FIG. 3a is a variation of a detail of FIG. 1 in side view;

FIG. 3b is a section taken along line IIIb-IIIb of FIG. 3a.

FIG. 4a is a further variation analogous to FIG. 3a;

FIG. 4b is a section taken along line IVb-IVb of FIG. 4a.

FIG. 5 is a further variation seen as in FIG. 3a;

FIG. 6 is an end view the device according to FIG. 1 in the direction of arrow VI of FIG. 1;

FIG. 7 is a perspective view of a variation of the embodiment according to FIG. 1 in a transverse view; and

FIG. 8 is a small-scale perspective view illustrating a variation on the embodiment of FIG. 7.

### SPECIFIC DESCRIPTION

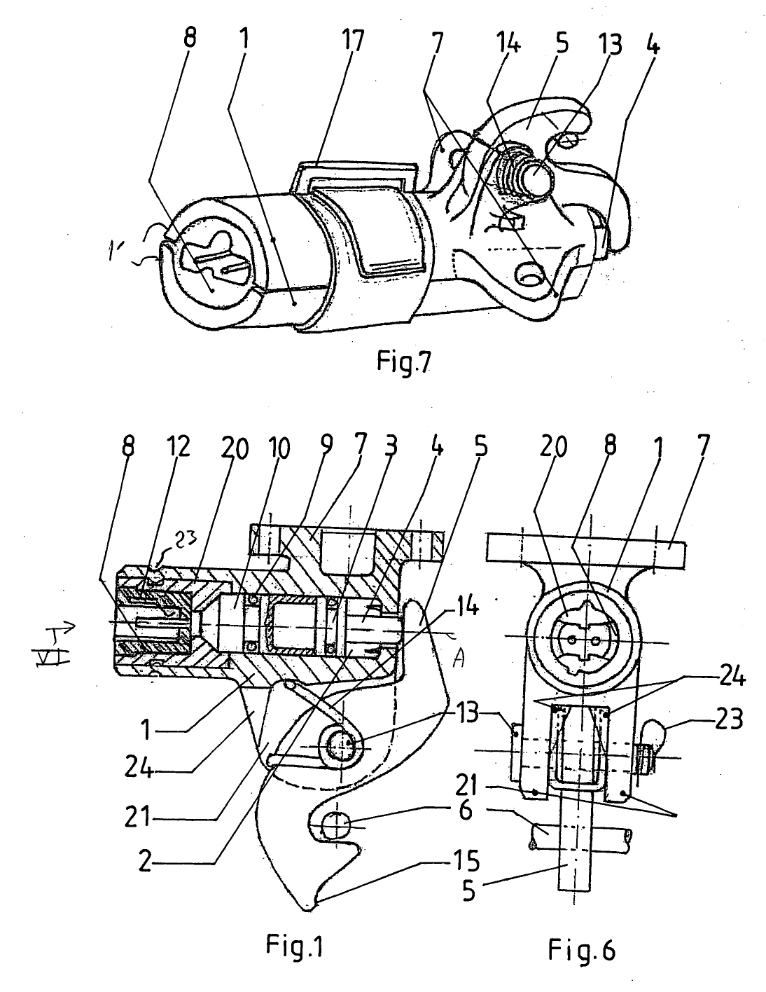

As seen in FIGS. 1, 6, and 7, a pyrotechnic actuator has a pyrotechnic charge 10, a seal ring 9, spacers 11, a retainer 8 and a shorting bar 12. These elements are situated in a housing 1 that has a cylindrically stepped chamber 2 centered on an axis A and in which a piston 3 is movable. The piston 3 can be moved from an initial inner position shown in the drawing into an end position by means of a quantity of gas released by ignition of the pyrotechnic charge 10 provided in the chamber 2. This way, the piston 3 is moved from the inner position of FIG. 1, in this case from left to right. In the outer end position a piston stem 4 of the piston 3 acts on a latch element 5, here a pawl, and moves it clockwise as shown in FIG. 1, so that a functional part 6 held by the latch element is unlocked. The functional part 6 is normally preloaded by a strong spring 14, for example, and coupled to the subsystem to be controlled, for example a belt tightener, a roll bar or the like.

According to the invention, the housing 1 is designed such that is has mounting ears parts 7 as an integral component, by means of which it can be fixed to parts of a motor vehicle. The part 7 can for example be a flange or the like, by means of which the whole unit can be fixed to a car body, for example by means of screws or nuts.

Furthermore, the housing 1 has at least one pivot for at least one element 5. Obviously, several pivots and several elements can be integrally designed.

In the embodiment the latch element is a pawl 5 mounted on a pivot that is integral to the housing 1. The latch pawl 5 is held by a biasing means, as shown for example in FIG. 1 at 14. In the embodiment this biasing means is a mechanical two leg torsion spring 14 that is braced with the ends of its legs on the one side against the housing 1 and on the other side against the side of the outer leg of the pawl 5. This spring 14 biases the latch element 5 the retaining or holding position shown in FIG. 1 as long as the actuator does not move the piston 3 and the piston stem 4. The latch element 5, particularly the pawl, has a projection shown at the lower end of FIG. 1, by means of which an experimental activation without the actuator being activated is possible by manual means.

Instead of the two-leg spring a different spring 14 can be used, for example a compression spring, braced against the lower free end of the latch 5 and the housing 1 or a spring washer, braced against the housing and acting on the latch.

In order to avoid destruction of the housing 1 when the piston 3 is moved subsequent to the explosion of the pyrotechnic charge 10 in the area hit by the piston 3, an element for damping the movement of the piston 3 is provided. The damping means is formed by parts of the housing 1 that are provided close to or on the perforated housing floor through which passes the piston stem 4. According to FIGS. 3a and 3b such damping means are bars or ribs 16 formed on the housing floor and projecting in the direction of the piston 3. The damping means can also be ribs formed on the housing floor and on the housing wall that are preferably tilted such that they form an obstacle to the movement of the piston 3 that increases with the length of the path covered. In the same way, this effect is achieved when the damping means is formed by a conical tapering 18 of the chamber of the housing 1 close to the housing floor, as illustrated in FIGS. 4a and 4b. Alternatively or additionally, a ring-shaped insert 19, made of metal or plastic or a combination of metal and plastic or any different adequate material can be provided as damping means between the perforated floor of the housing 1 and the piston 3 as shown in FIG. 5. Preferably, this ring-shaped insert 19 can be plastically deformed when hit by the piston 3. In any case, the corresponding kinetic energy of the piston 3 is transformed into plastic deformation without the housing 1 being destroyed.

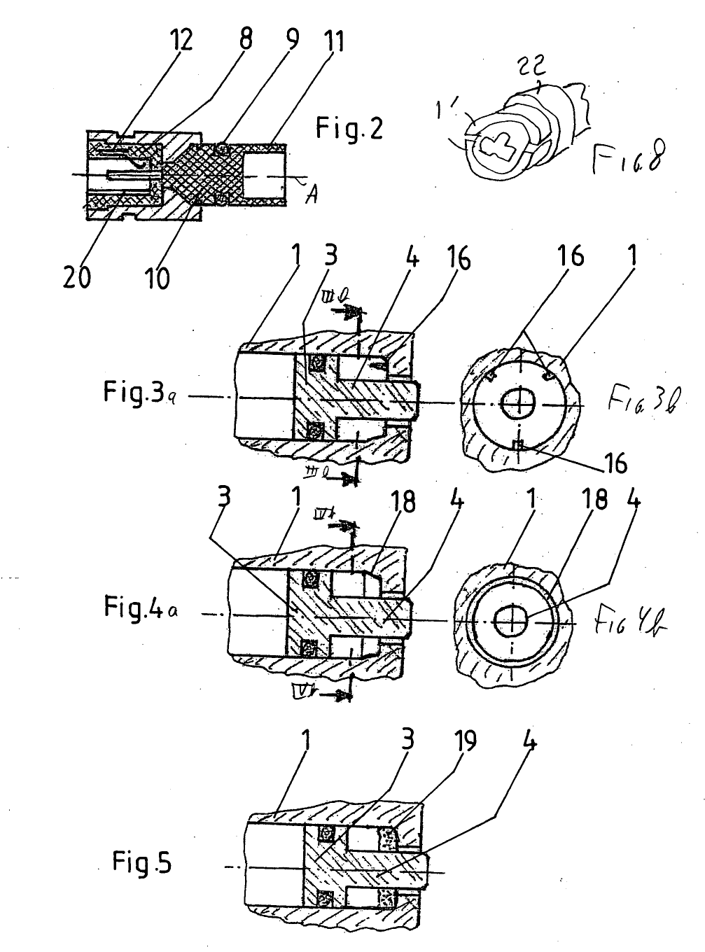

As shown as special feature in form of an individual part in FIG. 2, the pyrotechnic charge together with the shorting bar 12 and the retainer 8 are imbedded in an element 20, particularly in a sleeve and positioned such that it is stable and cannot be deformed. Thus, all components of the ignition set of the pyrotechnic charge 10 can be completely preinstalled by the manufacturer so that an installation unit that can be safely handled and that subsequently can be installed and inserted by the manufacturer of the whole system is created. The formed element 20 is inserted in a corresponding recess of the housing 1 and held in lace by crimps 23 as shown in FIG. 1. The housing chamber 2 is stepped and open to one side, into which the formed element 20 is inserted with all components. The pyrotechnic charge 10, in particular, projects from the element 20 toward the piston 3 and is inserted in the region of chamber 2 that is smaller than the part holding the sleeve 20. The pyrotechnic charge 10 has a seal ring 9 at its end projecting into the chamber and engaging the inner wall surface of the chamber 2. In addition, the pyrotechnic charge 10 has spacer formations 11 at its end facing the piston 3, for example formed as bars or of as a ring-like sleeve that abut the piston 3 in its rest position as can be seen in FIG. 1. Thus, the piston 3 is no longer movable so that no rattling noises or the like are produced.

As particularly illustrated in FIGS. 7 and 8, the housing 1 can consist of two longitudinally separated parts 1′ that are held together by fastening means in the standard installation position. In the preferred embodiment according to FIG. 7, a spring clamp 17 is provided as fastening means, encompassing the outer shell of the basically cylindrical housing. Instead of those fastening means, other fastening means may be provided, too. A spring-elastic tapered sleeve 22 as shown in FIG. 8 is advantageous since the housing tolerances can be adjusted without affecting the secure fastening subsequent to the final installation.

Particularly the illustration according to FIGS. 1 and 6 shows that the locking element 5 engages between two pivot eyes 21 that are integral components of the housing 1. The latch element 5 has a hole through which engages a pivot pin 13 that also engages in the two pivot eyes 21 and is for example secured by a spring clip 23. The pivot eyes 21 have clamp zones formed as ridges projections 24, preferably on both sides, in the regions along which parts of the latch element 5 move when shifted from the retailing position in the releasing position. Consequently, the gap between the pivot eyes 21 and the latch element 5 is increasingly narrowed so that movement of the latch element 5 is slowed and in the final position the latch element 5 is even clamped and thus held. In this way, the latch element 5 cannot spring back into the initial position without releasing the element 6 when the actuator is activated. Instead, the movement is slowed down sufficiently, so that it is certain that release of the part 6 occurs, although the spacing of the formations 24 may be such that the element 5 is wedged between the projections 24 in the activated position. Preferably, these projections 24 or the like are plastically deformed when hit by the latch element 5.

The invention is not limited to the embodiments but can be varied in the framework of the disclosure. All new individual and combined features displayed in the description and/or the drawings are considered to be fundamental for the invention.

We claim:

1. In combination with a part normally retained in a predetermined position, a pyrotechnic actuator comprising:
a housing formed unitarily with a pivot, formed unitarily with mounts for securing the housing to a motor vehicle, and forming a chamber extending along an axis;
a latch element mounted on the pivot and movable thereon between a holding position retaining the part in the predetermined position and a releasing position allowing the part to more out of the predetermined position;
a piston having a stem engageable with the latch element, the piston being movable axially in the chamber between an inner position with the latch element in the holding position and an outer position with the latch element in the releasing position; and
a pyrotechnic charge in the chamber detonatable to shift the piston into the outer position and thereby shift the latch element into the releasing position.

2. The pyrotechnic actuator defined in claim 1 wherein the latch element is a pawl and the pivot includes a pin passing through the pawl.

3. The pyrotechnic actuator defined in claim 2, further comprising
biasing means for urging the latch element into the holding position.

4. The pyrotechnic actuator defined in claim 3 wherein the biasing means is a spring braced between the latch element and the housing.

5. The pyrotechnic actuator defined in claim 4 wherein the spring is mounted on the housing at the pivot.

6. The pyrotechnic actuator defined in claim 4 wherein the spring is a torsion spring.

7. The pyrotechnic actuator defined in claim 1 wherein the housing has an axially inwardly facing end wall and the piston has a stem engageable through the end wall with the latch element, the actuator further comprising
means including structure on the end wall engageable with the piston for damping movement of the piston into the outer position.

8. The pyrotechnic actuator defined in claim 7 wherein the structure is a plastically deformable formation engaged by the piston on moving into the outer position.

9. The pyrotechnic actuator defined in claim 1 wherein the housing chamber is open axially away from the latch element, the actuator further comprising:
a sleeve set in the chamber;
a retainer set in the sleeve and carrying the pyrotechnic charge, the pyrotechnic charge and piston being between the sleeve and the latch element; and
means fixing the sleeve and pyrotechnic charge in the chamber.

10. The pyrotechnic actuator defined in claim 9 wherein the chamber and housing are generally cylindrical and the chamber is stepped.

11. The pyrotechnic actuator defined in claim 9 wherein the pyrotechnic charge projects out of the retainer toward the piston and the chamber is of smaller diameter around the pyrotechnic charge than around the sleeve.

12. The pyrotechnic actuator defined in claim 9 wherein the pyrotechnic charge is provided with a seal ring snugly engaging an inner wall of the chamber.

13. The pyrotechnic actuator defined in claim 9 wherein the pyrotechnic charge is provided with an axially extending spacer holding the piston at a spacing from the pyrotechnic charge in the inner position.

14. The pyrotechnic actuator defined in claim 1 wherein the housing is formed of a pair of transversely interfitting housing parts and a clamp engaged around the housing parts.

15. The pyrotechnic actuator defined in claim 14 wherein the clamp is a spring sleeve.

16. The pyrotechnic actuator defined in claim 14 wherein the clamp is a tapered sleeve fitted over the housing parts.

17. The pyrotechnic actuator defined in claim 1 wherein the pivot is formed by a pair of spaced eyes unitarily formed with the housing and flanking the latch element and by a pin extending through the eyes and through the latch element, the housing further being formed at the pivot with
damping formations between the eyes and engageable with the latch element in the releasing position to slow its movement a into the releasing position.

18. The pyrotechnic actuator defined in claim 17 wherein the damping formations are spaced such that they are plastically deformed by the latch element in the releasing position to retain the latch element therein.
